(19) United States
(12) Patent Application Publication
(10) Pub. No.: US 2004/0192270 A1
(43) Pub. Date: Sep. 30, 2004

(54) Hotlist system and method for communication devices

(76) Inventor: Stuart S. Kreitzer, Coral Springs, FL (US)

Correspondence Address: AKERMAN SENTERFITT, P.O. BOX 3188, WEST PALM BEACH, FL, 33402-3188, US

(21) Appl. No.: 10/402,489

(22) Filed: Mar. 28, 2003

(51) Int. Cl. H04M 3/42

(52) U.S. Cl. 455/414.1; 455/550.1

(57) ABSTRACT

A method (50) for creating a hotlist (28) and portable communication device (10) having a hotlist feature comprises a display (30) for displaying the hotlist and a processor (12) coupled to the display. The processor can be programmed to track calls (52) made from the portable communication device and maintaining a recent call list (14) and reorder (66) the recent call list using entries stored in association with other programs (56, 58, 60, or 62) within the portable communication device. The processor can be further programmed to track frequent calls and promote the frequent calls in the hotlist based on at least one among a frequency of the frequent calls, a timeframe of the frequent calls, a freshness of the frequent calls, an entry of the frequent call in a calendar program, and an entry of the frequent call in a ToDo list.

### CROSS-REFERENCE TO RELATED APPLICATIONS

Not applicable

### FIELD OF THE INVENTION

This invention relates generally to phonebooks or phone lists in communication devices, and more particularly to a system and method for using a hotlist in a portable communication device to provide a more efficient means of scrolling and initiating a call.

### BACKGROUND OF THE INVENTION

Most cellular phones include a recent call list feature that is somewhat predictive of future calls to be made by a particular user. Although a recent call list is usually a faster path to initiating a new call than scrolling through an entire alphabetically stored phonebook, a more efficient method would ideally require fewer key strokes in order to initiate a desired call. Of course, scrolling through an alphabetical phonebook can be improved upon by allowing jumps in the list based on the entered text, but this still fails to account for recent calls, the number of times a particular number has been dialed, or calendaring that may have additional information to provide greater predictive accuracy.

Many cellular phones, combination phones with personal digital assistants (PDAs), and smart phones include phonebooks as well as calendaring functions. Many of these higher tier phones include the recent call list feature described above, but fail to account for data stored in their calendaring function to provide a hotlist that can have greater predictive accuracy. Other references discuss relevant functions improving efficiency in other aspects of communication systems. U.S. Pat. No. 6,052,563 by William J. Macko discusses synchronizing certain functions of a communication device to a user's appointment book or daily activity calendar. For example, a pager or cellular phone would provide a silent alert if a calendar indicated that the user was in a staff meeting unless the user was being called by his or her boss. U.S. Pat. No. 5,905,789 by Craig Alexander Will discusses an adaptive model that looks at subscriber behavior to predict a phone number where a subscriber can be reached. U.S. Pat. No. 6,084,954 by Harless et al. discusses the prediction of outgoing calls after receiving an incoming call by detecting the pattern of outgoing calls a user makes after receiving certain incoming calls.

Time efficiency and productivity enhancements in portable communication products are desirable features in a marketplace driven by individual productivity. The more a portable communication device can predict and anticipate human behavior the more effective a tool it will become. With the increased processing power available in portable communication devices, such devices should utilize and analyze as much data available to it as possible. Although the references discussed above provide additional efficiency, none of the references described above provides a consolidated list of what a phone predicts will be the most likely calls a particular user or subscriber will make.

### SUMMARY OF THE INVENTION

A method and apparatus for providing a hotlist in a portable communication device can take advantage of additional programs and data available within the portable communication device to provide a more predictable and readily accessible list of likely calls a particular user or subscriber will make.

In a first aspect of the present invention, a method of forming a hotlist in a portable communication device comprises the steps of tracking calls made from the portable communication device, maintaining a recent call list, and reordering the recent call list using entries stored in association with other programs within the portable communication device to provide the hotlist. The method can further include the step of displaying the hotlist on a display of the portable communication device. The method can further include the steps of tracking frequent calls and promoting the frequent calls in the hotlist based on at least one among the frequency of the frequent calls, a timeframe of the frequent calls, a freshness of the frequent calls, an entry of the frequent call in a calendar program, and an entry of the frequent call in a ToDo list.

In a second aspect of the present invention, a portable communication device having a hotlist feature comprises a display for displaying a hotlist and a processor coupled to the display. The processor can be programmed to track calls made from the portable communication device and maintaining a recent call list and reorder the recent call list using entries stored in association with other programs within the portable communication device. The other programs can be a calendaring program, a ToDo list, or an email program. The processor can be further programmed to track frequent calls and promote the frequent calls in the hotlist based on at least one among a frequency of the frequent calls, a timeframe of the frequent calls, a freshness of the frequent calls, an entry of the frequent call in a calendar program, and an entry of the frequent call in a ToDo list. The hotlist can be displayed on a single scrollable screen of the display.

The portable communication device can be, but is not limited to, a cellular phone, a two-way trunked radio, a combination cellular phone and personal digital assistant, a smart phone, a home cordless phone, a wired phone, or a satellite phone.

### BRIEF DESCRIPTION OF THE DRAWINGS

FIG. 1 is a block diagram of a portable communication device capable of generating a hotlist in accordance with the present invention.

FIG. 2 illustrates a database that can be used in accordance with the present invention.

FIG. 3 illustrates data extracted from a ToDo list, a calendar, or from email in accordance with the present invention.

FIG. 4 illustrates hotlists at various different time periods in accordance with the present invention.

FIG. 5 is a flow chart illustrating a method of forming a hotlist in accordance with the present invention.

### DETAILED DESCRIPTION OF THE DRAWINGS

A hotlist in accordance with the present invention can be a list that contains phone numbers that are most likely to be called next by a user of a portable communication product or a phone subscriber in a carrier based communication system. Having a hotlist saves the user or subscriber time when dialing an outgoing call since it is faster than scrolling through the phonebook and more accurate in predicting future outgoing calls than a recent call list. The hotlist can typically be more predictive than the recent call list because it can look forward in time by consulting calendar and ToDo lists (or other data sources used in conjunction with programs in the portable communication device) as well as backwards by monitoring call history (or other old data in other programs) in multiple ways.

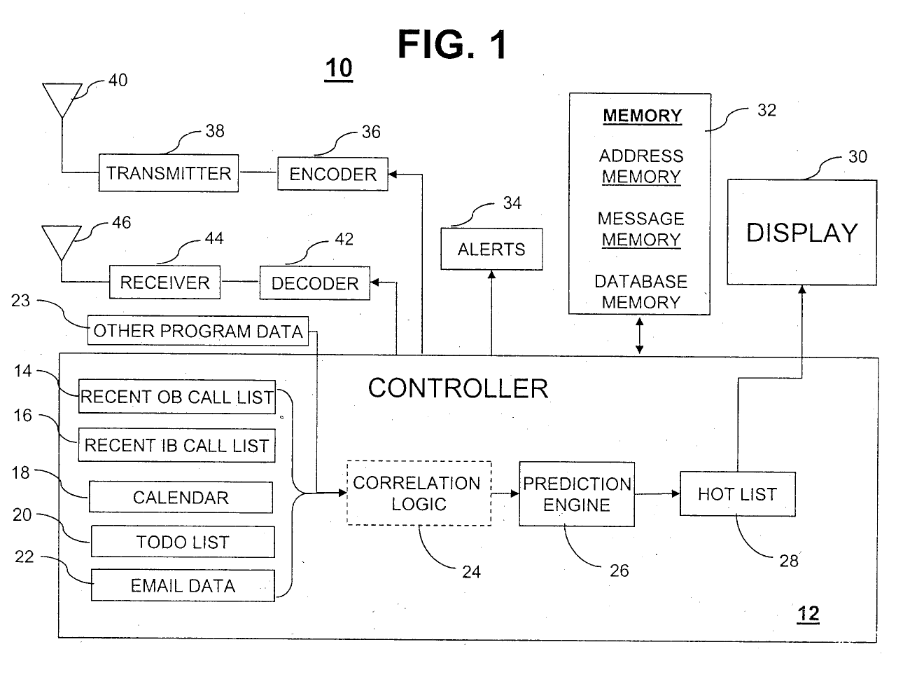

Referring to FIG. 1, a block diagram of a portable communication device 10 is shown. The device 10 can comprise, for example, a conventional cellular phone, a two-way trunked radio, a combination cellular phone and personal digital assistant, a smart phone, a home cordless phone, a satellite phone or even a wired phone having a hotlist feature in accordance with the present invention. In this particular embodiment, the portable communication device can include an encoder 36, transmitter 38 and antenna 40 for encoding and transmitting information as well as an antenna 46, receiver 44 and decoder 42 for receiving and decoding information sent to the portable communication device. The device 10 can further include an alert 34, memory 32 and a display 30 for at least displaying a hotlist. Ideally, the hotlist can be displayed on a single scrollable screen of the display 30. The device 10 can further include a processor or controller 12 coupled to the display 30, the encoder 36, the decoder 42, the alert 34, and the memory 32. The memory 32 can include address memory, message memory, and memory for database information.

The processor 12 is preferably programmed to track calls made from the portable communication device and maintain a recent call list. In this embodiment, there can be a recent outbound call list 14 and a recent inbound call list 16. The portable communication device 10 can further include other programs having data entries such as a calendar 18, a to do list 20, email data 22 or other program data 23. Although these programs and/or entries are shown within the controller or processor 12, the present invention is not limited in any way as to where or what these programs are or where the data resides. The processor 12 can also be programmed to reorder the recent call list (14) using entries stored in association with other programs (16, 18, 20, 22, 23, etc.) within the portable communication device 10. Thus, the processor can be programmed to reorder the recent call list 14 using entries stored in association with any one or more among the calendar 18, the to do list 20, email 22 or other programs having relevant data (23).

The programs residing within the portable communication device 10 may have different data entries (within the same program or among the different programs) referring to the same phone number. For example, “456-1111” in a recent call list can correlate to “MOM” in a to do list, a calendaring program or an email program. Thus, the portable communication device 10 can optionally include correlation logic 24 to enable the efficient and accurate utilization of entries among the different programs. The correlation logic 24 may require or prompt a user so that a particular phone number entry is uniquely tied to a particular person, object or vice-versa. In addition, the portable communication device 10 can include a prediction engine 26 that will reorder the recent call list 14 into a hotlist 28 as defined by the logic or rules of the prediction engine 26. The logic or rules in the prediction engine 26 can vary widely as long as the prediction engine 26 utilizes entries from the recent call list 14 and at least one other program or data source in the portable communication device 10.

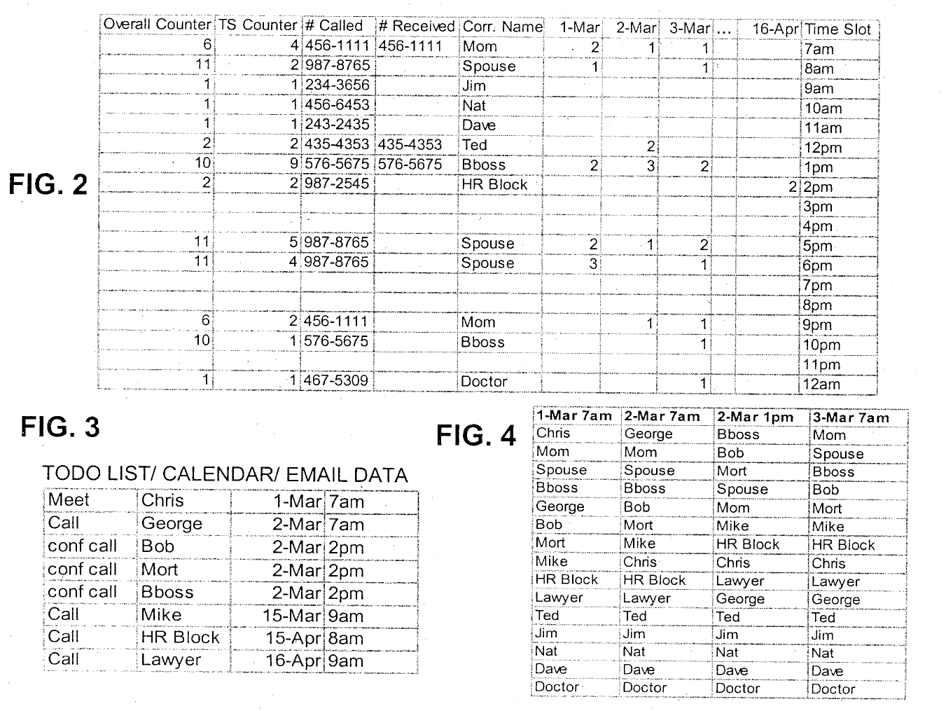

The processor 12 can be further programmed to track frequent outbound calls and optionally maintain a call tracking database as shown in FIG. 2. In this manner, the processor can promote a frequent outbound call (see “# called” column) on the hotlist 28 based on a likely timeslot a future call will be made. Similarly, the processor can track frequent inbound calls (see “# received” column) and promote a frequent inbound call on the hotlist based on a likely timeslot a return call can be made. In one embodiment, the processor 12 and/or prediction engine 26 can be programmed to track frequent calls and promote the frequent calls in the hotlist based on at least one among the frequency of the frequent calls (see “Overall Counter” column), the timeframe of the frequent calls (see “TS Counter”), the freshness of the frequent calls, the entry of the frequent call in a calendar program, and the entry of the frequent call in a ToDo list. If there are no entries currently stored in association with other programs within the portable communication device 10, then the processor 12 can be programmed to maintain the recent call list.

Pertinent data can be extracted from various programs and put in a program database similar to the one shown in FIG. 3. The call tracking database of FIG. 2 and the program database of FIG. 3 can then be correlated and run through the prediction engine 26 to create the hotlist 28.

An exemplary prediction engine 26 can make the hotlist as shown in FIG. 4 more predictive than a recent call list by using the following historical and future data collected for possible consideration in reordering the recent call list:

Upcoming Calendar events that contain contact names or numbers such as “call George to finish contract”. If the calendar has a pending appointment coming up in the next few minutes, the phone number or associated name or object should move to the top of the hotlist. Once the appointment passes or after a predetermined time lapses after the appointment, the contact can be removed from the hotlist or placed at a lower level on the hotlist. Names in the calendar event are resolved or correlated to numbers by searching a phonebook or the program database as shown in FIG. 3 before being added to the hotlist.

Some calls are repeatedly made at certain times according to an informal schedule. For example, a user might call his or her spouse every day while waiting in rush-hour traffic between 5-6 PM as shown in FIG. 2. Other examples are a worker who calls into the office every day at 1 PM to chat with his boss or a college student who calls her mother every day at 9 PM. The phone can track these informal events by keeping a count of numbers that are repeatedly called at certain times. For example, the phone can keep a scratchpad memory to track numbers called most often between 5-6 PM or between any given time period (hourly between 7 am and 12 am is shown in FIG. 2) and these frequently called numbers can be incrementally promoted to the top of the hotlist as the 5 o'clock hour approaches or any given incremental hour approaches. Note, assuming sufficient memory, the calls can be tracked in smaller increments (every 15 minutes or 5 minutes for example) to provide greater prediction accuracy.

As previously mentioned, To do list events containing contacts or phone numbers can also be added to the hotlist as their expiration time approaches. If there are no upcoming calendar events, to do's, or likely timeslot-based calls, the hotlist can be populated with the usual recent call list. The prediction engine can also use a maintained list of the most called numbers in the phonebook (see “Overall Counter” in FIG. 2) and keep these as a basis for the hotlist that can be superseded by calendar, ToDo, timeslot, and recent calls. Alternatively, the prediction engine can be set to allow superseding by other programs only if the count for a particular number of the most called numbers falls below a given count. The prediction engine may also account for the type of call being made in setting priority among phone numbers. For example, an upcoming conference call could have greater priority than a conflicting call or a most called number.

Another aspect of the prediction engine can specify that phone numbers can be promoted towards the top of the hotlist as the event time or time slot approaches. For example, for a 2 PM event such as a conference call, the phone number may be inserted at the 3^{rd} from the top hotlist position at 12PM and as the 2 o'clock hour approaches the number will be promoted to the 2^{nd} position and finally top-of-the-list a predetermined time before the event. A shown in FIG. 4, “Bboss”, “Bob”, and “Mort” are placed at the top of the list 1 hour before the designated conference call time of 2PM.

It is difficult to recommend a preferred method for ordering entries within the hotlist because there are many effective schemes and the exact scheme can be selected and honed by the product designers, particularly with feedback from actual users. However, as another example, one method for determining the order of numbers in the hotlist is to start by populating the hotlist with the recent call list at the top and most-called numbers at the bottom. The portable communication device can then promote predicted events from the calendar or ToDo list to the top of the list as their scheduled time approaches. Similarly, timeslot-based predictions can be promoted to the top of the list as the timeslot approaches. In some cases, the portable communication device can have a method for resolving a race condition such as when a calendar event and a timeslot event each vie for a high position in the list. One way to resolve the race condition is to have the portable communication device keep a count of how often each type of predictive call is actually dialed by the user and rank this type higher in the list. For example, if the user dials timeslot based calls more frequently than calendar calls, rank the timeslot calls higher in the list.

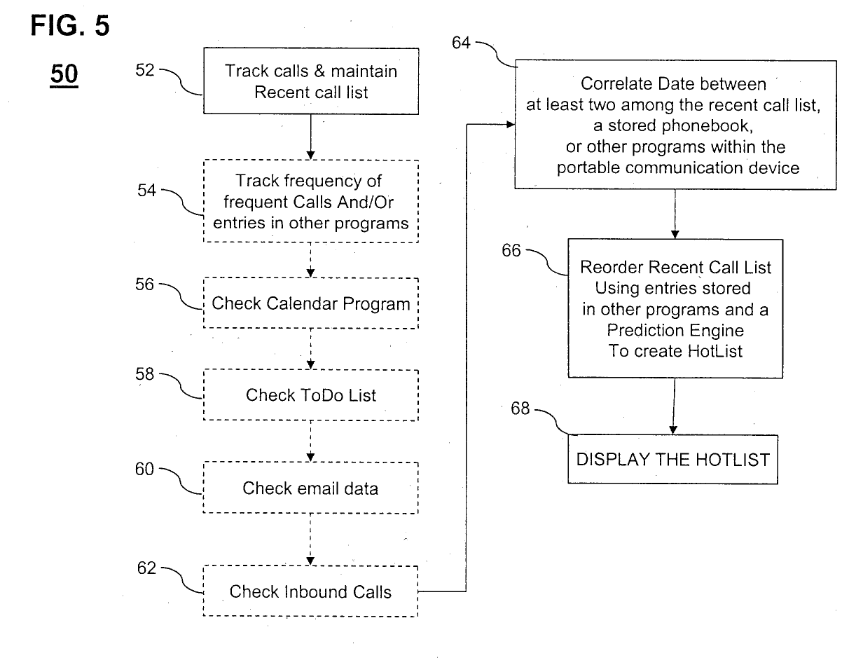

Referring to FIG. 5, a flow chart illustrating a method 50 of forming a hotlist in a portable communication device is shown. The method 50 can simply include the step 52 of tracking calls made from the portable communication device and maintaining a recent call list and the step 66 of reordering the recent call list using entries stored in association with other programs within the portable communication device to provide the hotlist. Then the hotlist could be displayed at step 68. The entries stored in association with other programs can include data associated with calendaring programs, ToDo lists, email, tracked outbound calls and tracked inbound calls. For example, the method 50 can include the step 54 of tracking the frequency of frequent calls and/or other entries in other programs. The method can optionally check one or more among calendaring programs at step 56, ToDo lists at step 58, email data at step 60 and inbound calls at step 62. The method can further comprise the step 64 of correlating data between at least two among the recent phone list, a stored phonebook, and the other programs within the portable communication device.

As mentioned with the examples above, the reordering step 66 can be achieved in different numerous ways based on the particular prediction engine or rules provided. For example, reordering can include the step of tracking frequent outbound calls and promoting a frequent outbound call on the hotlist based on a likely timeslot a future call will be made. Alternatively, frequent inbound calls can be tracked and a frequent inbound call on the hotlist can be promoted based on a likely timeslot a return call can be made. In yet another alternative, reordering can include the step of tracking frequent calls and promoting the frequent calls in the hotlist based on at least one among the frequency of the frequent calls, the timeframe of the frequent calls, the freshness of the frequent calls, the entry of the frequent call in a calendar program, and the entry of the frequent call in a ToDo list. An entry in the calendaring program can be promoted towards a top of the hotlist as a calendaring event time approaches or an entry in the ToDo list can be promoted or demoted in the hotlist as a function of the ordering in the ToDo list. An entry from the hotlist can be removed or given a reduced priority on the hotlist once the entry associated with a calendar event has expired for a predetermined time. The method further comprises maintaining the recent call list if there are no entries currently stored in association with other programs within the portable communication device.

In light of the foregoing description of the invention, it should be recognized that the present invention can be realized in hardware, software, or a combination of hardware and software. A method and system for creating and utilizing a hotlist in a communication device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. A computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

What is claimed is:

1. A method of forming a hotlist in a portable communication device, comprising the steps of:
tracking calls made from the portable communication device and maintaining a recent call list; and
reordering the recent call list using entries stored in association with at least one other program within the portable communication device to provide the hotlist.

2. The method of claim 1, wherein the method further comprises the step of displaying the hotlist on a display of the portable communication device.

3. The method of claim 1, wherein the step of reordering comprises the step of reordering the recent call list using entries stored in association with a calendaring program.

4. The method of claim 1, wherein the step of reordering comprises the step of reordering the recent call list using entries stored in association with a ToDo list program.

5. The method of claim 1, wherein the method further comprises the step of tracking frequent outbound calls and promoting a frequent outbound call on the hotlist based on a likely timeslot a future call will be made.

6. The method of claim 1, wherein the method further comprises the step of tracking frequent inbound calls and promoting a frequent inbound call on the hotlist based on a likely timeslot a return call can be made.

7. The method of claim 1, wherein the method further comprises the step of tracking frequent calls and promoting the frequent calls in the hotlist based on at least one among the frequency of the frequent calls, the timeframe of the frequent calls, the freshness of the frequent calls, the entry of the frequent call in a calendar program, and the entry of the frequent call in a ToDo list.

8. The method of claim 1, wherein the method further comprises the step of correlating data between at least two among the recent phone list, a stored phonebook, and the other programs within the portable communication device.

9. The method of claim 3, wherein the method further comprises removing an entry from the hotlist once the entry associated with a calendar event has expired for a predetermined time.

10. The method of claim 1, wherein the method further comprises maintaining the recent call list if there are no entries currently stored in association with other programs within the portable communication device.

11. The method of claim 3, wherein the method further comprises promoting an entry on the calendaring program towards a top of the hotlist as a calendaring event time approaches.

12. The method of claim 4, wherein the method further comprises promoting an entry on the ToDo list towards the top of the hotlist as a function of the ordering in the ToDo list.

13. A portable communication device having a hotlist feature, comprising:
a display for displaying a hotlist;
a processor coupled to the display, wherein the processor is programmed to:
track calls made from the portable communication device and maintaining a recent call list; and
reorder the recent call list using entries stored in association with at least one other program within the portable communication device.

14. The portable communication device of claim 13, wherein the processor is further programmed to reorder the recent call list using entries stored in association with a calendaring program.

15. The portable communication device of claim 13, wherein the processor is further programmed to reorder the recent call list using entries stored in association with a ToDo list program.

16. The portable communication device of claim 13, wherein the processor is further programmed to track frequent outbound calls and promote a frequent outbound call on the hotlist based on a likely timeslot a future call will be made.

17. The portable communication device of claim 13, wherein the processor is further programmed to track frequent inbound calls and promote a frequent inbound call on the hotlist based on a likely timeslot a return call can be made.

18. The portable communication device of claim 13, wherein the processor is further programmed to track frequent calls and promote the frequent calls in the hotlist based on at least one among the frequency of the frequent calls, the timeframe of the frequent calls, the freshness of the frequent calls, the entry of the frequent call in a calendar program, and the entry of the frequent call in a ToDo list.

19. The portable communication device of claim 13, wherein the processor is further programmed to maintain the recent call list if there are no entries currently stored in association with other programs within the portable communication device.

20. The portable communication device of claim 13, wherein the portable communication device is selected from the group of devices comprising a cellular phone, a two-way trunked radio, a combination cellular phone and personal digital assistant, a smart phone, a home cordless phone, a wired phone, and a satellite phone.

21. The portable communication device of claim 13, wherein the processor is further programmed to display the hotlist on a single scrollable screen of the display.
